(19) United States
(12) Patent Application Publication
(10) Pub. No.: US 2007/0294949 A1
(43) Pub. Date: Dec. 27, 2007

(54) Window Lifter Assembly

(75) Inventors: Marko Hermann, Eschwege (DE); Christoph Hesse, Olpe (DE); Damien Hugele, Sieburg (DE); Claus Mangold, Helsa (DE); Enrico Schliwa, Lauchroden (DE)

Correspondence Address: KAPLAN GILMAN GIBSON & DERNIER L.L.P., 900 ROUTE 9 NORTH, WOODBRIDGE, NJ, 07095, US

(73) Assignee: FAURECIA INNENRAUM SYSTEME GMBH, Hagenbach (DE)

(21) Appl. No.: 11/719,992

(22) PCT Filed: Dec. 13, 2005
(86) PCT No.: PCT/EP05/13494

§ 371 Date: Sep. 7, 2007

(30) Foreign Application Priority Data
Dec. 17, 2004 (DE) 10 2004 062 167.5

(51) Int. Cl. E05F 15/16

(52) U.S. Cl. 49/349

(57) ABSTRACT

A window lifter arrangement, in particular for the side windows of an automotive vehicle, containing a drive- and guide mechanism for driving and guiding a window pane which is retained by a window pane retainer, and a stop component which is a stop member for the window pane retainer, characterised in that window pane retainer and stop component are fixed to each other by a form-fitting and/or frictional and/or integral mounted connection, this mounted connection being able to be separated by an initial actuation of the window pane retainer for opening or closing the window pane.

The present invention relates to a window lifter arrangement and also to an automotive vehicle door which contains such a window lifter arrangement.

Window lifter arrangements for side window panes of automotive vehicles are known. Such known window lifter arrangements according to the state of the art have a drive- and guide mechanism for driving and guiding a window pane which is associated with the window lifter arrangement and retained in a window pane retainer,

During installation of such a window lifter arrangement, in particular in an automotive vehicle door, normally the window lifter arrangement is firstly integrated into the automotive vehicle door without the window pane and the window pane is only mounted after production of the entire automotive vehicle door. During mounting of the window pane, the window pane is fitted from the exterior into an opening gap which is provided for the window pane and located in the window breast of the automotive vehicle door. Subsequently, the window pane is inserted into the window breast until the window pane reaches the window pane retainer which is located already in the vehicle door. In order to produce a secure connection between window pane and window pane retainer, catching lugs are generally located on the window pane holder and, if the window pane has been introduced correctly, lock in provided recesses in the window pane.

Correct introduction of the window panes so that the catching lugs which are located on the window pane retainer lock in the window pane or a similarly formed connection is produced, is time-consuming and demands manual skill of the assembler. In addition, mounting can be made significantly difficult in the case where the window pane retainer is not located in a defined initial position during mounting of the window pane and/or slips away or tilts during mounting of the window pane, as a result of which the time expenditure on mounting increases considerably.

The present invention has the object therefore of producing a window lifter arrangement which makes it possible to mount the window pane with a defined position of the window pane retainer.

This object is achieved by a window lifter arrangement or an automotive vehicle door according to the independent claims.

The invention relates to a window lifter arrangement, containing a drive- and guide mechanism for driving and guiding a window pane which is retained by a window pane retainer, and to a stop component which is a stop member for the window pane retainer of such a type that window pane retainer and stop component are fixed to each other by a form-fitting and/or frictional and/or integral mounted connection, this mounted connection being able to be separated by an initial actuation of the window pane retainer for opening or closing the window pane.

As a result of the fact that the window pane retainer is fixed to the stop component by a form-fitting and/or frictional and/or integral mounted connection, the window pane retainer is retained in a defined position and the window pane can be mounted without the window pane retainer slipping away or tilting. A substantially lower time expenditure during mounting of the window pane is associated therewith. As a result of the fact that this mounted connection can be separated by an initial actuation of the window pane retainer for opening or closing the window pane, it is possible, after mounting the window pane, to operate the window lifter arrangement without further complexity.

Advantageous developments of the invention are described in the dependent patent claims.

An advantageous development provides that one or more elastic damping elements are located on the window pane retainer and/or on the stop component, said damping elements damping striking of the window pane retainer against the stop component in the case of a separated mounted connection. During operation of the window lifter arrangement, the window pane retainer is prevented in this way from striking hard against the stop component which is damaging in the long term for the drive unit. If the window lifter arrangement is operated manually, such damping of the stop member is also more pleasant for the operator.

A further advantageous development provides that the mounted connection is provided between the window pane retainer and the stop component in that an elastic fixing element is fitted securely on one of the two components, and an undercut recess is located in the other of the two components, and the fixing element is connected in a form-fit to the undercut recess, and the fixing element is of such a type that it engages over the undercut recess when the two separated components are guided together. The elastic fixing element hence fulfils two objects: firstly, in the unseparated state of the window pane retainer and of the stop component, it effects a mounted connection as a result of the undercut and of the form-fit. If the window lifter arrangement is actuated and hence the window pane retainer, then the fixing element is detached out of the undercut as a result of its elasticity and releases the movement of the window pane retainer and hence of the window pane. When the window pane retainer and the stop component are guided together, the elastic fixing element engages over the undercut since the opening thereof is too small for penetration of the fixing element. As a result of the elasticity of the fixing element, the guiding together is damped; this damping of the stop member of the window pane retainer against the stop component is the second function of the thus-configured elastic fixing element.

A further advantageous development provides that the fixing element comprises one or more plastic materials of the group thermoplastic elastomers, polyurethanes, rubbers, in particular butadienes, and has a Shore A hardness in the range of 60 to 85. Plastic materials from these groups and with a Shore A hardness in the indicated range are particularly suitable for such an elastic fixing element.

It is noted at this point that the above details of plastic materials only indicate a preferred selection of the plastic material groups which are expedient. As a result, use of other plastic materials from the group of elastomers and elastomer derivatives is not intended to be precluded in principle.

A further advantageous development provides that the mounted connection is provided between the window pane retainer and the stop component in that the window pane retainer and the stop component are connected by webs which are destroyed under the effect of force. Such webs can be modified in different embodiments, e.g. as narrow plastic or metal lamellae which break off upon an initial actuation of the window pane retainer, as foamed material jaws which are pulled apart, jaws which are supported against each other and fitted on window pane retainer and stop component and are held together by an adhesive connection, and the like.

A further advantageous development provides that the window pane retainer can be actuated such that the window pane which is retained in the window pane retainer is guided, independently of the direction of movement thereof, along a specific guide edge of the guide mechanism. The drive- and guide mechanism is produced in such a manner that the actuation force for moving the pane is applied to the latter such that said pane is pressed, independently of the direction of movement thereof (i.e. the pane moving up or down), constantly against a specific guide edge of the guide mechanism (i.e. merely a single one which is constant for each direction of movement). The advantageous development differs from the state of the art in particular in that the actuation force is pressed, independently of the direction of movement thereof, constantly against a specific guide edge of the guide mechanism which is established accurately during the construction phase of the window lifter arrangement. An attempt is therefore made, in addition to the direction of movement (i.e. the “main direction of movement”) of the pane, to rotate the latter in addition for example such that the latter is always pressed against a very specific guide edge. It is hereby sought as the ideal state that complete abutment of the relevant pane edge parallel to the guide edge is provided, in that a Bowden cable vector direction for example is set in a suitable manner, for instance via adjustment of deflection elements, such as rollers etc. It should therefore be sought that the pane is applied and/or rotated in a translatory manner, in that as good abutment as possible of the relevant pane edge on the desired guide edge is provided. For this purpose, a mechanism must therefore be provided which enables alignment in a very specific spatial direction both when moving the pane up and when moving it down. The longest outer guide rail in which the pane is guided is possible as guide edge (for example in the case of vehicle doors, normally the guide rails disposed in the A- and C column).

A window lifter arrangement of this type can dispense with additional guide rails which guide the window pane retainer, which implies an advantage with respect to the weight and spatial requirement relative to normal window lifter arrangements in which the window pane retainer is guided. In the case of such a window lifter arrangement in which the window pane retainer is not retained by a guide rail and as a result mounting of the window pane is particularly complex, the above-described mounted connection is particularly expedient.

A further advantageous development provides that a first and a second force application point of the drive mechanism are provided on the window pane retainer, the first force application point being loaded more strongly during actuation of the drive mechanism in a first direction and, during actuation in a second direction which is opposite to the first direction, the second application point being loaded more strongly. As a result of the unequal loading of the force application points in the different directions of movement, easy rotation and/or translatory displacement of the pane is achieved which hence even enables parallel abutment of the pane on a specific guide edge.

A further advantageous development provides that the window pane retainer is actuated by a linear element which is associated with the drive mechanism, in particular a chain or a Bowden cable. This development is sensible in particular in the case of these linear elements which often can transmit only tensile loads (and do not achieve an additional supporting action of the pane). Of course, the invention can however be applied also to linear elements such as toothed racks etc.

A further advantageous development provides that the drive mechanism has rollers for deflecting linear elements.

The invention is explained with reference to several Figures, which show:

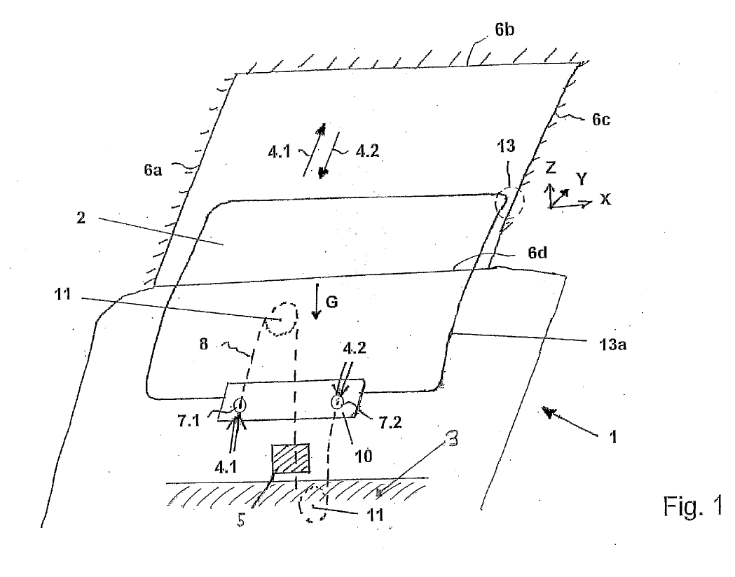

FIG. 1 a vehicle door having a window lifter arrangement according to the invention,

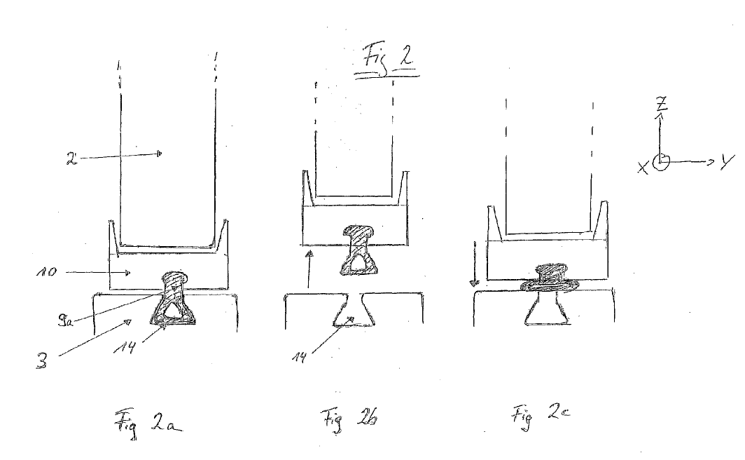

FIG. 2a-2c a first embodiment of a mounted connection according to the invention,

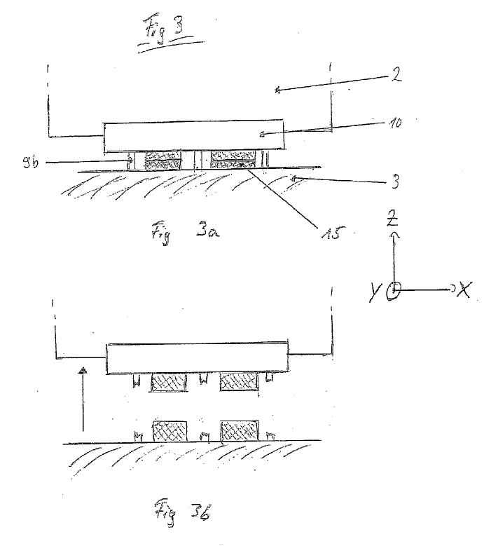

FIG. 3a-3b a second embodiment of a mounted connection according to the invention.

FIG. 1 shows a window lifter arrangement according to the invention. This is disposed in a rear automotive vehicle door of a car which is shown in FIG. 1 in outline. The delimitation lines 6a to 6d hereby show the delimitations of the window opening, line 6d hereby represents a window breast, line 6a a guide rail for a window pane 2 disposed on the C column and also 6c a guide rail for the window pane 2 disposed on the B column. The guide rails 6a or 6c and also the slot disposed in the breast 6d form, in FIG. 1, the guide mechanism for the window pane 2.

The window pane 2 (the centre of gravity of which is shown by “G” with an arrow located beside it) is moved up or down by a drive mechanism at the behest of an operator (this movement takes place mainly in the X-Z plane, in particular mainly in the Z direction). A small proportion is however also provided in the Y direction since the pane concerns a pane which is curved in a plurality of spatial directions.

The drive mechanism has a cable 8 (i.e. a linear element) which is looped around deflection pieces 11 which are configured as rollers. The drive of the cable is effected by an electric motor of the drive mechanism 5 which is operated according to the wishes of the occupants (of course manual operation of the cable is also possible).

The linear element 8 is connected to a window pane retainer 10 which is clamped to the underside of the pane and is in addition screwed thereon so that the window pane retainer is securely connected to the pane or represents a component thereof. The linear element is connected, on the one hand, at a first force application point 7.1 and, on the other hand, at a second application point 7.2 to the window pane retainer 10.

The movement of the window pane retainer 10 downwards (in the negative Z direction) is delimited by a stop component 3 (the drive mechanism S is offset backwards in the X-Z plane relative to the window pane retainer 10 and hence does not impede a movement of the window pane retainer). This stop component 3 is connected to the frame of the vehicle door, which is not shown here however in more detail. The stop component 3 is configured in such a manner that it offers a wide stop surface for the window pane retainer 10 along the X axis and along the Y axis. Embodiments of the window pane retainer 10 and of the stop component 3 with a mounted connection according to the invention are shown only in FIGS. 2a-2c or 3a, 3b for the sake of clarity.

The drive- and guide mechanism is produced in such a manner that the actuation force for moving the window pane is applied to the window pane 2 such that the latter is pressed, independently of the direction of movement thereof, constantly against a specific guide edge of the guide mechanism. This means that the window pane 2 is presently moved preferably by the entire right edge thereof, designated in FIG. 1 with 13a, such that said edge abuts parallel on the guide edge 6c or such that the window pane 2 is tilted with its portion 13 (i.e. the upper corner directed towards the C column which is indicated in FIG. 1 by a broken-line circle) always in the direction of the guide edge 6c. This takes place independently of the main direction of movement of the window pane 2, i.e. independently of whether this is moved up or down.

This is explained concretely once again in the following. As described above already, the linear element 8 associated with the drive mechanism 5 is connected, on the one hand, to the first force application point 7.1 and, on the other hand, to the second force application point 7.2. Upon actuation of the drive mechanism in a first direction (4.1, this can be seen by the movement arrows within the window opening, the tension of the linear element 8 and hence the tensile force thereof likewise act in this direction, as the double arrow on the fixing part 10 shows), the force application point 7.1 is firstly loaded since the linear element 8 pulls on the first force application point 7.1. Here the first force application point is therefore loaded more strongly than the second force application point 7.2. The first force application point 7.1 is hereby chosen with respect to the centre of gravity of the window pane 2 centre of gravity including window pane retainer 10 such that the window pane 2 is loaded, on the one hand, by the direction of the resulting force at the force application point and also a resulting moment (in the X-Z plane with a right-rotating moment) such that the portion 13a (or in the unfavourable case only the portion 13) is guided in the rail 6c or is pressed against the latter. During a downward movement in the direction 4.2, the result is in contrast tension in the opposite direction, i.e. by tension in the direction 4.2 at the second application point 7.2, the result is likewise a right-rotating moment so that, even in the case of this opposite movement, the portion 13a or portion 13 is pressed into the rail 6c. It may be noted that these typically ideal force representations described here can be modified in that the weight can be predominantly strong when lowering the window pane 2, i.e. no strong tension 7.2 is necessary at the second application point in order to move the latter downwards. Springs can be provided at the force application points or in the chain for the force application points. In the case of a change in the direction of movement, a change in the direction of rotation of the moment of the window pane is avoided by correct choice of the preadjustments of the spring force. Thus the window pane does not detach from the provided guide edge (e.g. the guide edge on the B column). Also by means of configuration of the entire drive mechanism (for example the arrangement of the rollers 11 or of the motor with respect to the centre of gravity of the window pane) or else adjustments in the frictional forces in the guide rails 6a or 6b and the springs, it can hereby be ensured that the result is, as far as possible, total parallel abutment of the window pane with its portion 13a against the guide rail 6c.

FIGS. 2a-2c show a first embodiment of a mounted connection according to the invention.

FIG. 2a shows in a cross-section in the Z-Y plane, the window pane retainer 10 on which an elastic fixing element 9a made of a thermoplastic elastomer with a Shore A hardness of 75 is mounted, and the stop component 3 in which an undercut recess 14 is located. The elastic fixing element 9a is connected in a form-fit to the undercut recess 14, as a result of which window pane retainer 10 and stop component 3 are fixed to each other.

The undercut recess 14 in this embodiment has in the illustrated cross-section a funnel-like shape which continues in a channel-like manner for a distance in the X direction, not visible in this Figure. At its end which engages into the undercut recess, the elastic fixing element likewise has a shape which is configured funnel-like in the Y-Z plane, as a channel in the X direction and is hollowed out in addition in the interior. With the other end, the fixing element is securely connected to the window pane retainer via a form-fitting connection, this form-fit being configured via a cylinder-like undercut and the fixing element being solid at this end, i.e. without hollowing out.

In total two connections of this type are located between window pane retainer 10 and stop component 3, these connections being disposed for the sake of stability at as great a spacing as possible in the X axis. Of course, a plurality of such connections is just as possible as only one such connection.

FIG. 2b shows the window pane retainer 10 and the stop component 3 in the case of a separated mounted connection in the upwards movement, i.e. in the Z direction, of the window pane retainer. This case is intended to represent the sequence of the initial actuation of the window pane retainer. Starting from the situation represented in FIG. 2a, if the window pane retainer is actuated, then, by the delimitation of the undercut opening 14, a force is exerted on the elastic fixing element 9a. This force leads to the elastic fixing element 9a being compressed at its lower end due to its elasticity, as a result of which the cross-sectional surface is reduced in size in the Z-Y plane. This reduction in size of the cross-sectional surface of the lower end of the fixing element 9a is substantially assisted by the hollowing out thereof. The consequence is that the elastic fixing element detaches from the undercut opening 14 under the corresponding force effect. The desired force application of the initial actuation of the window pane retainer can be chosen by choice of the material of the elastic fixing element, by the shape of the undercut opening and by the hollowed-out volume.

FIG. 2c shows the window pane retainer 10 and the stop component 3 in the case of a separated mounted connection in the downwards movement, i.e. in the negative Z direction, of the window pane retainer. In the illustrated situation, the fixing element 9a which is mounted on the window pane retainer reaches the undercut recess 14 which is located in the stop component 3. Because of the funnel-like shape of the undercut recess 14 and fixing element 9a, penetration of the fixing element into the undercut recess 14 is prevented. As a result of this chosen shape, flattening of the fixing element at the inlet of the undercut recess is ensured, as illustrated in the Figure. Because of this overlapping, undesired restoration of the mounted connection is avoided. A further advantageous effect is achieved by this construction according to the invention: when guiding the window pane retainer 10 and the stop component 3 together, striking of the two components is damped because of the elastic properties of the fixing element 9a.

FIGS. 3a and 3b show a second embodiment of a mounted connection according to the invention.

FIG. 3a, in a cross-section in the X-Z plane, shows the window pane retainer 10 and the stop component 3 which are fixed to each other by a mounted connection. The mounted connection in this embodiment is produced by three plastic lamellae 9b made of polypropylene which are disposed at the greatest possible spacing in the X direction. Furthermore, two damping blocks 15 which are situated one upon the other and made of foamed material are located between respectively two adjacent plastic lamellae 9b and are mounted on the window pane retainer 10 or on the stop component 3.

FIG. 3b shows the window pane retainer 10 and the stop component 3 in the case of a separated mounted connection in the upwards movement, i.e. in the z direction, of the window pane retainer. This case is intended to represent the sequence of the initial actuation of the window pane retainer. Starting from the situation represented in FIG. 3a, if the window pane retainer is actuated, then the plastic lamellae 9b break at a specific force application. This force application can be adjusted as desired via the choice of material of the plastic lamella or via the shape of the plastic lamella. If the window pane retainer 10 and the stop component 3 are now guided back together again by lowering the window pane 2, then there is no longer any possibility that an undesired connection of window pane retainer 10 and stop component 3 is produced again. At the same time, the guiding together of these two components is damped by the damping blocks 15.

1. A window lifter arrangement for side windows of an automotive vehicle, comprising:
a drive and guide mechanism for driving and guiding a window pane;
a window pane retainer operable to retain the window pane; and
a stop component operable as a stop member for the window pane retainer,
wherein the window pane retainer and stop component are fixed to each other by a form-fitting and/or frictional and/or integral mounted connection, which is operable to be separated by an initial actuation of the window pane retainer for opening or closing the window pane.

2. The window lifter arrangement according to claim 1, wherein one or more elastic damping elements are located on the window pane retainer and/or on the stop component, said damping elements damping striking of the window pane retainer against the stop component in case of a separated mounted connection.

3. The window lifter arrangement according to claim 2, wherein:
the mounted connection is provided between the window pane retainer and the stop component,
an elastic fixing element is fitted securely on one of the two components,
an undercut recess is located in the other of the two components,
the fixing element is connected in a form-fit to the undercut recess, and
the fixing element is of such a type that it engages over the undercut recess when the two separated components are guided together.

4. The window lifter arrangement according to claim 3, wherein:
the fixing element comprises one or more plastic materials taken from the group consisting of: thermoplastic elastomers, polyurethanes or rubbers, butadienes, and
the fixing element has a Shore A hardness in the range of about 60 to 85.

5. The window lifter arrangement according to claim 1, wherein:
the mounted connection is provided between the window pane retainer and the stop component, and
the window pane retainer and the stop component are connected by webs, which are destroyed under the effect of force.

6. The window lifter arrangement according to claim 1, wherein the window pane retainer is operable such that the window pane which is retained in the window pane retainer is guided, independently of the direction of movement thereof, along a specific guide edge of the guide mechanism.

7. The window lifter arrangement according to claim 6, wherein a first and a second force application point of the drive mechanism are provided on the window pane retainer, the first force application point being loaded more strongly during actuation of the drive mechanism in a first direction and, during actuation in a second direction, which is opposite to the first direction, the second application point being loaded more strongly.

8. The window lifter arrangement according to claim 6, wherein the window pane retainer is actuated by a linear element which is associated with the drive mechanism, the drive mechanism being taken from the group consisting of: a Bowden cable and a toothed rack.

9. The window lifter arrangement according to claim 8, wherein the drive mechanism has rollers for deflecting linear elements.

10. An automotive vehicle door, containing a window lifter arrangement according to claim 1.
